(19) United States
(12) Patent Application Publication
(10) Pub. No.: US 2012/0281097 A1
(43) Pub. Date: Nov. 8, 2012

(54) VEHICLE MEDIA SYSTEM

(76) Inventor: David Wood, Orlando, FL (US)

(21) Appl. No.: 13/102,423

(22) Filed: May 6, 2011

(51) Int. Cl. H04N 5/33; G09G 5/08; G10L 11/00

(52) U.S. Cl. 348/164; 704/275; 345/158; 704/E11.001; 348/E05.09

(57) ABSTRACT

A vehicle media system is disclosed. The system includes a media unit mounted to a headrest of the vehicle. The media unit includes a video camera oriented towards a passenger area of the vehicle and an infrared camera configured to capture infrared images. A display monitor is disposed in the vehicle in a field-of-view of a vehicle operator to display images captured by the video camera.

### TECHNICAL FIELD

This disclosure relates to a vehicle media system. More particularly, the disclosure relates to a media system within the headrest of a vehicle.

### BACKGROUND

The statements in this section merely provide background information related to the present disclosure and may not constitute prior art.

A vehicle headrest, typically provided in an automobile or airplane, having a vehicle-mounted support typically fixed in a seat back and a cushion against which the occupant of the seat can rest the back of his or her head is known. Headrests provide protection against whiplash by preventing the occupant's head from snapping too far back when rebounding after a front-end collision or simply moving back in a rear-end collision. Recently, media systems have been incorporated into backs of headrests, providing vehicle occupants the opportunity to view entertainment or educational video programs.

Existing media headrest systems lack a camera device to permit front seat vehicle passengers and occupants to monitor rear seat passengers and/or take pictures. Many vehicle operators shuttling young passengers would benefit from a system configured to present real-time viewing of rear seat passengers to a forward viewing vehicle operator. In this way, the vehicle operator may decrease time glancing away from a vehicle path. Thus, there is a need for embodiments of a headrest media system to include a camera device.

A further difficultly with existing media headrest systems is the need to manually control operation of the media headrest system using the attached control interface, usually on the facade of the media headrest system attached to the headrest or via a hand held remote control. This design requires rear seat passengers to move in their seats or locate a remote control, limiting the amount of control any one passenger can have over the media headrest system and introducing an element of inconvenience associated with remote operation. Thus, there is a need for an infrared camera device in the headrest system to detect reflective or direct infrared wavelengths to control and manipulate system functions using hands movements detected by the infrared camera. Similarly, integrated voice command capabilities adapted to control operation of the media headrest system would overcome existing manual and remote control problems. In this way, rear seat passengers can remain safely secured in the seat belt restraint while operating the media headrest system.

A further deficiency with existing media headrest system designs is an absence of a focused light source. In many cases light sources incorporated into a vehicle by an original equipment manufacturer can interfere with a sight of the vehicle operator. The light sources are not incorporated into the seat back or headrest of a vehicle so as to utilize the bulk of the seat to inhibit light from projecting forward towards the vehicle operator. Thus, there is a need to embodiments of a headrest media system to include a focused light source.

### SUMMARY

A vehicle media system is disclosed. The system includes a media unit mounted to a headrest of the vehicle. The media unit includes a video camera oriented towards a passenger area of the vehicle and an infrared camera configured to capture infrared images. A display monitor is disposed in the vehicle in a field-of-view of a vehicle operator and/or a front seat passenger to display images captured by the video camera.

Certain embodiments of the invention include a feature of utilizing infrared images to control operation of the media unit.

Certain embodiments of the invention include a feature of controlling operation of the media unit using a microphone.

Certain embodiments of the invention include a feature for utilizing a focused light source to illuminate an area at or near a media system.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 is a perspective view of an exemplary headrest, in accordance with an embodiment of the disclosure; and

FIG. 2 is a schematic illustration of a vehicle media system, in accordance with an embodiment of the disclosure.

### DETAILED DESCRIPTION

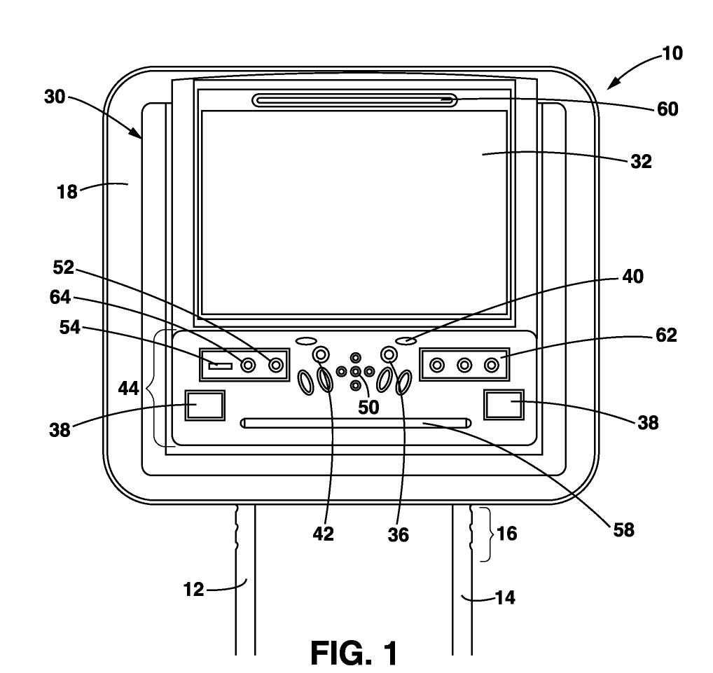

Referring now to the drawings, wherein the showings are for the purpose of illustrating certain exemplary embodiments only and not for the purpose of limiting the same, FIG. 1 illustrates an exemplary embodiment of a headrest 10. As FIG. 1 shows, the headrest has a seat bar including a first rod 12 and a second rod 14 for insertion into a seatback of a vehicular seat. Sawtooth notches 16 on the confronting edges of the first and second rods 12 and 14 allow the height of the headrest 10 above the seat back to be adjusted according to operator preference. The headrest 10 can be arranged to pivot limitedly about a horizontal axis. The headrest 10 is preferably covered with a fabric cover 18 having a front face (not shown) to support a back of a head of a person sitting in the vehicular seat. Preferably, the fabric cover 18 is configured to hold cushioning material such as expanded polypropylene foam within the headrest 10. The headrest 10 includes a headrest media system 30 that may be incorporated into the headrest using any one of a number of known configurations including e.g., a conventional brick design and/or a front loading design such as that described in U.S. patent application Ser. No. 13/102,342, the contents of which are incorporated herein by reference. Brick design media headrest systems are typically installed in a headrest as an aftermarket product where the headrest is modified to accept the media system. The disclosure herein can be applied to various embodiments of a headrest media system and is therefore not intended to be limited thereby.

The headrest 10 includes a headrest media system 30 having a media source device, a video monitor 32, an electro-optical imaging device 36 (hereafter referred to as a video camera), a light source 38, a microphone 40, a second electro-optical imaging device 42 (hereafter referred to as an infrared camera), and a media control interface 44 for controlling the headrest media system 30.

The video monitor 32 may be any type of known visual display unit such as an LCD type display, plasma, an organic LED, or electro-luminescent display. The media source device can be communicatively connected to the headrest media system 30 using one of multiple known communication means such as an HDMI cable or wireless radio communications to supply audio and/or video signals. Power, ground, and additional audio/video inputs and outputs may be connected to or from the headrest media system 30.

The media source device may be any one of multiple known content sources including, for example, an optical media drive such as a digital video disc (DVD) player or Blu-Ray® player, a video game counsel or other set-top-box, audio device, a CD-ROM player, a television tuner, a radio tuner, a wireless receiver, an MP3 player, a digital video recorder (DVR), a device for playing media supplied from a portable storage device (e.g., a portable hard drive, memory cards, flash memory, and other solid-state memory) and/or a device for playing media supplied from a portable media player, for example, an audio or video device such as an iPod®, iPad®, and iTouch®. Additionally or alternatively, the media source device may be configured as a universal docking device to permit front loading of an external device via a front face of the headrest media system 30. In this way, an operator may physically insert an external media device such as an IPOD®, into the docking device in a front forward manner, i.e., a direction X as shown in FIG. 1.

The video camera 36 may operate in the visible, near-infrared, or any appropriate spectrum, and may utilize a CCD (charge-coupled device) or CMOS (complimentary metal-oxide semiconductor) imaging sensors. The video camera 36 may utilize one of many focusing lenses including a short or wide field-of-view lens to capture images that are proximately located near to headrest. The video camera 36 can be mounted on the headrest media system 30 and preferably included on the media control interface 44.

The light source 38, can be any light emitting device configured to produce light including incandescent bulbs and light-emitting diodes (LEDs) such as white light-emitting diodes. The LEDs are preferably aligned with lenses formed from a generally clear material. In one embodiment, the light source 38 includes an outer and inner lens. The outer lens is included over the light source 38 to provide a focusing feature such as concave optics, convex optics, pyramid optics, pillow optics, and/or textured surfaces. The inner lens provides a focusing feature to create a more focused beam for a reading/map light beam while the rest of the outer lens or pillow lens provides a more diffused light that encompasses the focused portion. The inner and outer lenses allow a single light source to act as both a map lamp and a courtesy lamp. Alternatively, a single lens may be included over the light source 38 to emit a focused reading/map light beam. The light source 38 may be controlled by a switch located in an easy to reach area, preferably on the media control interface 44.

The infrared camera 42 may be any known thermographic imaging device configured to capture infrared radiation, preferably in the near infrared spectrum. The infrared camera 42 may utilize one of many focusing lenses to capture images that are proximately located near to headrest. The infrared camera 42 can be mounted on the headrest media system 30 and preferably included on the media control interface 44.

The media control interface 44 includes a plurality of media control buttons configured to control operation of the headrest media system 30 including control of the video monitor 32 and the media source device. Exemplary control buttons 50 that may be included in an embodiment of the disclosure can include, a power button, a screen mode button for controlling aspect ratio, play and stop buttons for controlling play of a video program and a source button for controlling the source of a program (e.g., DVD or auxiliary input). A headphone jack 52 can also be positioned on the front face of the headrest media system 30. In one embodiment, a USB connection port 54, communicatively connected to the media source device, is included on the media control interface 44.

In one embodiment of the media control interface 44, a slot 58 can be included and configured for front loading access of a media storage device, such as an optical media disc, or an external media device such as an iPod®, iPad® or MP3 player, for example. In one embodiment, the headrest media system 30 can include an infrared transmitter 60 for transmitting, for example, audio signals to wireless headphones, and for receiving remote control signals. RCA Jacks 62 may be incorporated into the headrest media system 30, in one embodiment, for receiving and transmitting audio and video signals. An auxiliary input jack 64 may be included to receive communication signals from an external media device. The disclosure herein can be applied to various configurations and arrangements of control features on the media control interface 44 and is therefore not intended to be limited thereby.

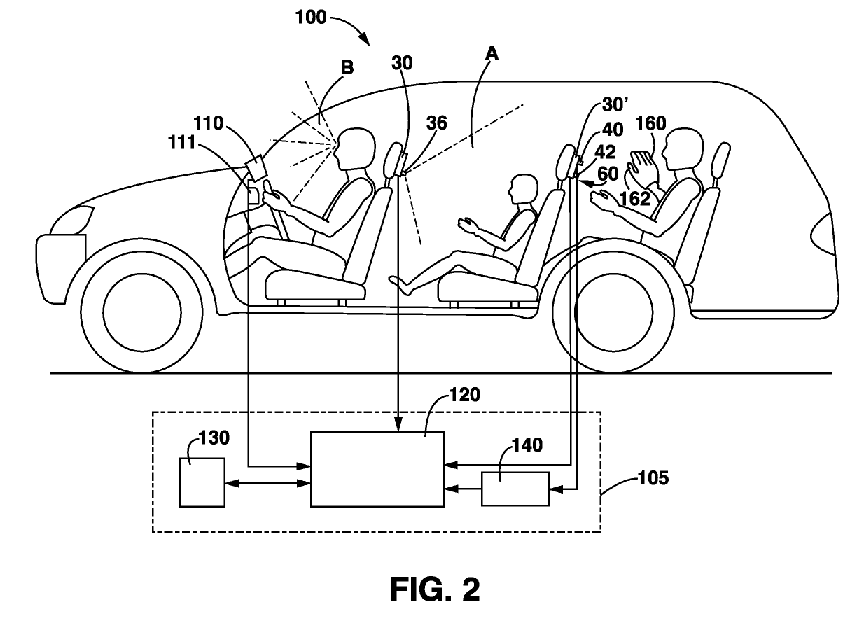

FIG. 2 is a schematic illustration of a vehicle media system 100. As shown, the vehicle media system 100 includes the headrest media system 30, a display monitor 110, and a control unit 105. A second headrest media system 30′ is shown for ease of illustration and it should be recognized that the functions performed by, and the components incorporated into, the second headrest media system 30′ may be performed and incorporated in the headrest media system 30. As described herein above, the headrest media system 30 includes the video camera 36. The second headrest media system 30′ includes the infrared camera 42 and the microphone 40.

The display monitor 110 may be any type of known visual display unit such as an LCD type display, plasma, an organic LED, or electro-luminescent display. The display monitor 110 may be a multiple purpose display. For example, the display monitor 110 can additionally function to display navigation maps in vehicles implementing navigation systems, or as a monitor for vehicles equipped with back up cameras. To this end, display monitor 110 can be installed as an additional component to a vehicle or can include a suitable display monitor factory installed in a vehicle. The display monitor 110 is preferably disposed in a field-of-view B of a vehicle operator in a location that is easily viewed by the vehicle operator. For example, in one embodiment, the display monitor 110 can be disposed within a rear view minor of the vehicle. In another exemplary embodiment, the display monitor 110 can be disposed within a navigation system of a vehicle. The display monitor 110 may also be disposed in other places of the vehicle such as within or near a dashboard of the vehicle, and/or in a heads up display utilizing a vehicle windshield.

The control unit 105 preferably includes a processor 120, memory 130, and an audio processing module 140. Certain embodiments of the control unit 105 include additional components such as input interface circuit, an output interface circuit, and computer bus. The computer bus serves to transmit programs, data, status and other information or signals between the various components of the computer system control unit 105 and can be any suitable physical or logical means of connecting computer systems and components. The memory 130 can be any type of suitable memory. This could include the various types of dynamic random access memory (DRAM) such as SDRAM, the various types of static RAM (SRAM), and the various types of non-volatile memory (PROM, EPROM, and flash). It should be appreciated that components of the control unit 105 may be included in the headrest media system 30 and that functions performed by the control unit 105 may be performed by components within the headrest media system alternatively or in addition to execution in the control unit 105.

The processor 120 performs computation and control functions of the control unit 105 including processing image information from the video camera 36 and the infrared camera 42 and controls the display monitor 110, as discussed below. The processor 120 may be any type of processor or multiple processors, single integrated circuits such as a microprocessor, or any suitable number of integrated circuit devices and/or circuit boards working in cooperation to accomplish the functions of a processing unit. During operation, the processor 120 executes one or more programs contained within the memory 130 to control operation of the vehicle media system 100.

The microphone 40 can be coupled to the audio processing module 140 and communicatively connected to the processor 120. The audio processing module 140 may include appropriate filter and amplifier circuitry and an analog-to-digital (A/D) converter, which digitizes the voice input from a vehicle passenger and supplies the digitized voice to the processor 120, which may execute a speech recognition application, which causes the voice input to be compared to system recognized commands. The voice input provided by vehicle passenger through the microphone 40 may be utilized to control functions of the headrest media system 30. The processor 120 may execute various routines in determining whether the voice input corresponds to a system recognized command.

The processor 120 is communicatively connected to the video camera 36. The processor 120 processes digital imagery received from video camera 36 for display on the display monitor 110 and is configured to control operation of the video camera 36. A user interface 111 may be implemented in a vehicle dashboard to control operation of the video camera 36 via the processor 120. The user interface allows communication to the control unit 105, for example from a system driver and/or another computer system, and can be implemented using any suitable method and apparatus. In one embodiment, the user interface includes one or more network interfaces to communicate with other systems or components. Certain functions may be implemented on a user interface included on the headrest media system 30 and certain functions may be implemented on a user interface included on a dashboard.

As shown in FIG. 2, the video camera 36 can be oriented to image the passenger region A. In operation, the display monitor 110 receives digital images of the passenger region A from video camera 36 for display to the vehicle operator via the display monitor 110. The processor 120 may control the video camera 36 based upon user inputs. The video camera 36 may be directly coupled to the display monitor 110 to supply images directly to the display, thus reducing the processing burden on the processor 120. In one embodiment, the processor 120 may be configured to control an operating state of the system 30, and more particularly the video camera 36, based upon audio input from the microphone 40. For example, the processor 120 may be configured to transition the video camera 36 to an ON operating state when a sharp noise is detected from the passenger area such as a baby's cry. The captured video is then broadcast to the display monitor 110 for viewing by the vehicle operator. In one embodiment, a series of still images are broadcast to the display monitor 110 to avoid distraction.

The processor 120 is communicatively connected to the infrared camera 42. In one embodiment, the infrared camera 42 can be included to detect reflective or direct infrared wavelengths from an operator to control and manipulate system functions of the headrest media system 30 by interpreting hand movements of an operator. Reflective infrared may originate from the infrared transmitter 60 or by other suitable means known to those of skill in the art. The image information provided by the infrared camera 42 corresponding to hand configurations of an operator may be utilized to control functions of the headrest media system 30. To this end, image information can be compared with predetermined system information (which can be stored in the memory 130) to recognize system commands. The processor 120 may therefore execute various routines in determining whether the image information from the infrared camera 42 corresponds to a system recognized command.

In one embodiment, an operator can utilize one or more gloves 160, for example, having infrared reflective coating 162 disposed on the fingertips of the glove(s). The reflective coating 162 can act to reflect infrared light provided by the infrared transmitter 60. In operation, motion and position of infrared reflections off of the fingertips are utilized to determine system commands. For example, a predetermined system command may comprise and open, stationary hand whereby each reflective fingertip is visible to the IR camera 42. In another embodiment, the system can receive commands based on the head movements of a user. To this end, the processor 120 can be configured to track head motion using the infrared camera 42 by comparing subsequent captured infrared images of the operator and using known head tracking algorithms. Head tracking information may be used to manipulate the screen, cursor, and/or as input for system commands, among other uses, for example.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A media system for a vehicle, comprising:
a display monitor disposed in the vehicle in a field-of-view of a vehicle operator; and
a media unit mounted to a headrest of a vehicle, said media unit including
a video camera oriented towards a passenger area of the vehicle, and
an infrared camera configured to capture infrared images.

2. The media system of claim 1, wherein the media unit is mounted to the headrest to form a brick headrest design.

3. The media system of claim 1, wherein the media unit is configured for front loading access of a media storage device.

4. The media system of claim 1, further comprising:
a light source disposed on the media unit and configured to emit a focused light beam.

5. The media system of claim 4, wherein the light source comprises an inner lens configured to emit a focused light beam and an outer lens configured to provide a diffused light beam to encompass the focused light beam.

6. The media system of claim 1, wherein said media unit further includes
a media content unit configured to receive media content,
a media display unit configured to display the media content, and
a user interface configured to control the content unit and the media display unit.

7. The media system of claim 1, wherein the display monitor is additionally configured to display at least one of a navigational map and a back up camera view.

8. The media system of claim 1, further comprising:
a microphone; and
a processing module configured to control operation of the media unit based upon sound from the microphone supplied by an operator.

9. The media system of claim 8, wherein the processing module is further configured to digitize voice input from the operator, identify speech within the digitized voice input, and control operation of the media unit based upon the identified speech and a set of predetermined system commands associated with predetermined keywords.

10. The media system of claim 8, wherein the video camera is configured to supply images to the display monitor.

11. The media system of claim 10, wherein the processing module is further configured to control operation of the video camera and the display monitor based upon sound input from the microphone.

12. The media system of claim 1, wherein the infrared camera is communicatively connected to a processing module configured to interpret infrared images supplied by the infrared camera and control operation of the media unit based upon the interpreted infrared images.

13. The media system of claim 12, wherein the interpret infrared images comprises:
comparing captured infrared images with predetermined system information associated with hand movements;
identifying a hand movement associated with the captured infrared images; and
executing system commands associated with the identified hand movement to control operation of the media unit.

14. A media system for a vehicle, comprising:
a display monitor communicatively connected to a video camera of a media unit and configured to display captured images from the video camera, the display monitor disposed in the vehicle in a field-of-view of a vehicle operator, the video camera oriented towards a passenger area of the vehicle;
a microphone;
an infrared camera mounted in the media unit and configured to capture infrared images; and
a processing module communicatively connected to the display monitor, the video camera, the microphone, and the infrared camera and configured to control operation of the media unit based upon input from the microphone and the infrared camera.

15. The media system of claim 14, further comprising a light source disposed on the media unit and configured to emit a focused light beam.

16. The media system of claim 14, wherein the processing module is further configured to control operation of the media unit based upon sound information from the microphone, to control operation of the video camera and the display monitor based upon sound input from the microphone, and to control operation of the media unit based upon infrared images supplied by the infrared camera.

17. A method for operating a media system of a vehicle, the method comprising:
mounting a media unit to a headrest, the media unit comprising a microphone, an infrared camera configured to capture infrared images, and a video camera oriented towards a passenger area of the vehicle;
connecting the media unit to a display monitor, the display monitor configured to display images supplied by the video camera to a vehicle operator; and
controlling operation of the media unit based upon information received by the infrared camera and the microphone.

18. The method of claim 17, wherein the media system comprises a processing module communicatively connected to the display monitor, the video camera, the microphone, and the infrared camera, and wherein the processing module is configured to control operation of the media unit based upon input from the microphone and the infrared camera.

19. The method of claim 17, wherein the media unit further comprises a light source configured to selectively emit a focused light beam.

20. The method of claim 17, further comprising:
displaying captured images from the video camera on the display monitor.

21. The method of claim 20, further comprising:
displaying the captured images from the video camera based upon sound input from the microphone.

22. The method of claim 17, wherein the media unit is mounted to the headrest to form a brick headrest design.

23. The method of claim 17, wherein the media unit is configured for front loading access of a media storage device.

24. The method of claim 17, wherein the information received by the infrared camera is used to track an operator's head movement.

25. The method of claim 17, wherein the information received by the infrared camera comprises hand configurations associated with system commands.
